(19) United States
(12) Patent Application Publication
(10) Pub. No.: US 2012/0147541 A1
(43) Pub. Date: Jun. 14, 2012

(54) ELECTRONIC DEVICE, COMPUTER BACK COVER AND ASSEMBLING METHOD OF COMPUTER BACK COVER

(75) Inventors: Yung-Hui Chen, Taipei City (TW); Juo-Ti Chen, Taipei City (TW); Po-An Lin, Taipei City (TW); Kuo-Nan Ling, Taipei City (TW)

(73) Assignee: COMPAL ELECTRONICS, INC., Taipei City (TW)

(21) Appl. No.: 13/026,301

(22) Filed: Feb. 14, 2011

(30) Foreign Application Priority Data
Dec. 8, 2010 (TW) 99142858

(51) Int. Cl. G06F 1/16; B23P 11/00

(52) U.S. Cl. 361/679.21; 29/428

(57) ABSTRACT

An electronic device includes a computer back cover, a bezel, and a display panel. The computer back cover includes a back cover and a frame. The frame includes a plurality of parts. The parts are locked together by engagement and connected to the back cover. The bezel is assembled to the parts and has an opening. The display panel is assembled between the bezel and the parts and exposed by the opening.

### CROSS-REFERENCE TO RELATED APPLICATION

This application claims the priority benefit of Taiwan application serial no. 99142858, filed on Dec. 8, 2010. The entirety of the above-mentioned patent application is hereby incorporated by reference herein and made a part of this specification.

### BACKGROUND OF THE INVENTION

1. Field of the Invention

The invention relates to an electronic device, a computer back cover adapted to an electronic device, and an assembling method of a computer back cover. More particularly, the invention relates to a notebook computer back cover and an assembling method of a notebook computer back cover.

2. Description of Related Art

A typical notebook computer is constituted by a host and a display pivotally connected to the host. Since the host and the display are pivoted relatively, a user is allowed to close the notebook computer through the relative pivoting between host and the display in order for the notebook computer to be conveniently portable. When use of the notebook computer is desired, the display can be opened up and operated conveniently.

In general, the display includes a computer back cover, a bezel, and a display panel assembled between the computer back cover and the bezel. Specifically, the computer back cover includes a frame and a back cover that are connected together, and the display panel is assembled between the frame and the bezel. To facilitate delivery and processing of the computer, the frame can include a plurality of parts which can be separately delivered and individually processed. However, in the process of connecting the parts to the back cover, a fixture is required for fixing the relative positions of the parts, which leads to an increase in manufacturing costs and time.

### SUMMARY OF THE INVENTION

The invention is directed to an electronic device of which a computer back cover can be easily fabricated and assembled.

The invention is further directed to a computer back cover that can be easily fabricated and assembled.

The invention is further directed to an assembling method of a computer back cover. By applying the assembling method, manufacturing costs can be lowered down.

In an embodiment of the invention, an electronic device includes a computer back cover, a bezel, and a display panel. The computer back cover includes a back cover and a frame. The frame includes a plurality of parts. The parts are locked together by engagement and connected to the back cover. The bezel is assembled to the parts and has an opening. The display panel is assembled between the bezel and the parts and exposed by the opening.

In an embodiment of the invention, a computer back cover is adapted to an electronic device. The electronic device has a bezel and a display panel. The bezel has an opening. The computer back cover includes a back cover and a frame. The frame includes a plurality of parts which are locked together by engagement and connected to the back cover. The bezel is assembled to the parts. The display panel is assembled between the bezel and the parts and exposed by the opening.

According to an embodiment of the invention, the back cover is rectangular. The parts include a first part, a second part, a third part, and a fourth part. The first part is connected to one long side of the back cover. The second part is connected to one short side of the back cover, and a first end of the second part and a first end of the first part are locked. The third part is connected to the other long side of the back cover, and a first end of the third part and a second end of the second part are locked. The fourth part is connected to the other short side of the back cover. A first end of the fourth part and a second end of the first part are locked, and a second end of the fourth part and a second end of the third part are locked.

According to an embodiment of the invention, the first end is a locking hook and the second end is a slot.

According to an embodiment of the invention, the parts are connected to the back cover by thermal compression.

According to an embodiment of the invention, a material of the parts is plastic, aluminum, or magnesium.

According to an embodiment of the invention, one of the parts and another one of the parts are made of different materials.

According to an embodiment of the invention, a material of the back cover is metal.

According to an embodiment of the invention, the material of the back cover is aluminum.

In an embodiment of the invention, an assembling method of a computer back cover is provided. A frame is assembled by locking a plurality of parts by engagement. The frame is connected to a back cover to assemble the computer back cover. The computer back cover can be connected to a bezel and a display panel through assembling the display panel between the bezel and the frame and exposing the display panel by an opening of the bezel.

According to an embodiment of the invention, the parts include a first part, a second part, a third part, and a fourth part. A method of assembling the frame by locking the parts includes locking a first end of the second part and a first end of the first part, locking a first end of the third part and a second end of the second part, locking a first end of the fourth part and a second end of the first part, and locking a second end of the third part and a second end of the fourth part.

According to an embodiment of the invention, the first end is a locking hook and the second end is a slot.

According to an embodiment of the invention, the back cover is rectangular. A method of connecting the frame to the back cover includes connecting the first part to one long side of the back cover, connecting the second part to one short side of the back cover, connecting the third part to the other long side of the back cover, and connecting the fourth part to the other short side of the back cover.

According to an embodiment of the invention, a method of connecting the frame to the back cover includes thermal compression.

According to an embodiment of the invention, a method of thermally compressing the frame onto the back cover includes coating the frame or the back cover with an adhesive, and heating and compressing the frame and the back cover.

Based on the above, the frame includes the parts according to the invention. Therefore, during fabrication, each of the parts can be separately delivered and individually processed, so as to facilitate the manufacture of the frame. In addition, the parts are locked together by engagement and then connected to the back cover, so as to assemble the computer back cover. Hence, when the frame is connected to the back cover, it is not necessary to fix the relative positions of the parts by using a fixture, which simplifies the assembling process and reduces the manufacturing costs and time.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view illustrating an electronic device according to an embodiment of the invention.

FIG. 2 is an explosive view illustrating the electronic device depicted in FIG. 1.

FIG. 3 is an explosive view illustrating the frame depicted in FIG. 2.

FIG. 4 is a three-dimensional view illustrating the back cover depicted in FIG. 2.

FIG. 5A to FIG. 5E illustrate a process for assembling the computer back cover depicted in FIG. 2.

### DESCRIPTION OF EMBODIMENTS

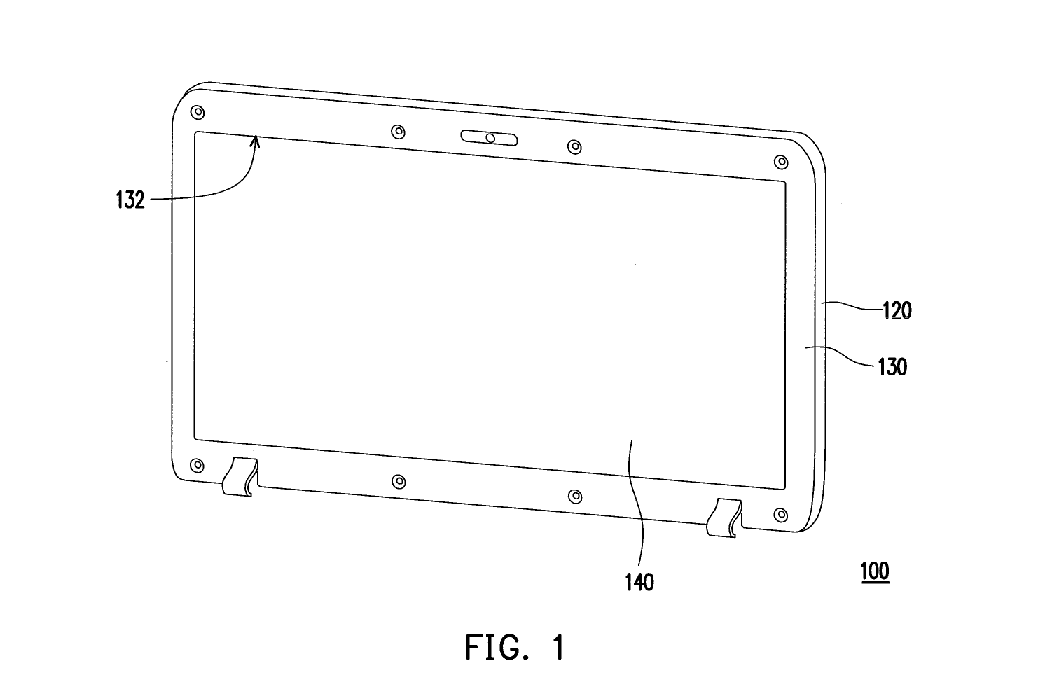

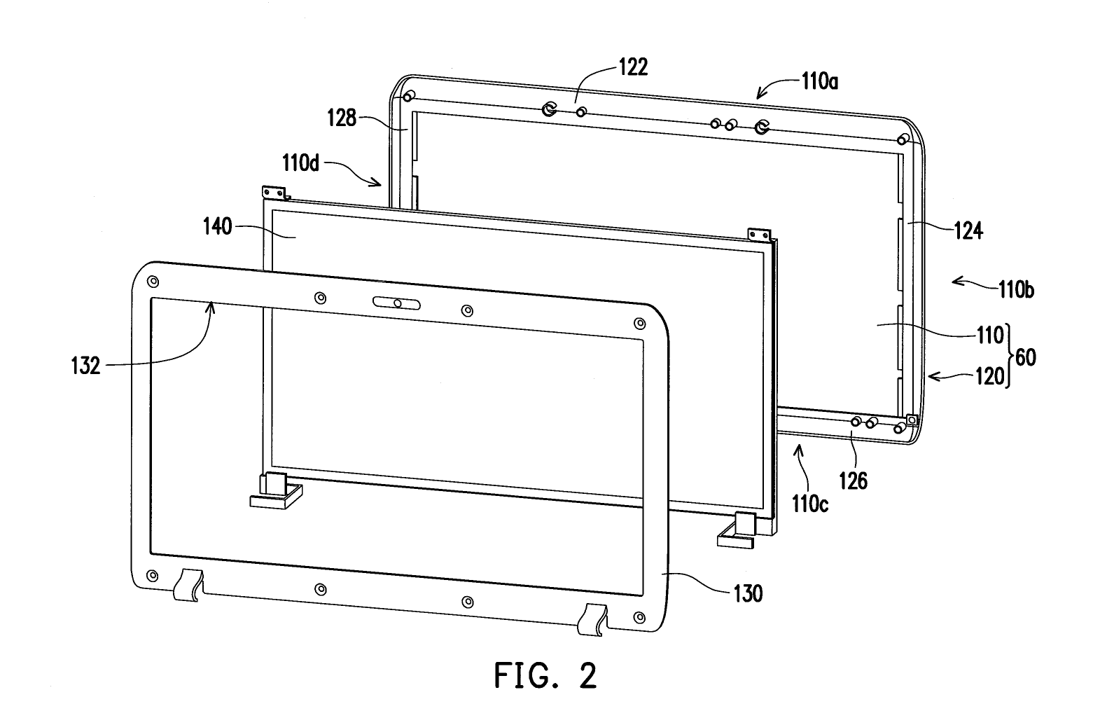

FIG. 1 is a three-dimensional view illustrating an electronic device according to an embodiment of the invention. FIG. 2 is an explosive view illustrating the electronic device depicted in FIG. 1. With reference to FIG. 1 and FIG. 2, the electronic device 100 of this embodiment is a notebook computer, for instance, and a display of the notebook computer includes a back cover 110, a frame 120, a bezel 130, and a display panel 140. The frame 120 includes parts 122, 124, 126, and 128 that are engaged and locked together and connected to the back cover 110, such that the back cover 110 and the frame 120 together assemble the computer back cover 60. The bezel 130 is assembled to the part 126 and has an opening 132. Here, the bezel 130 is, for instance, locked to the part 126 by a screw or by a locking hook, which should however not be construed as a limitation to the invention. The bezel 130 can also be assembled to other parts in a different way. The display panel 140 is assembled between the bezel 130 and the frame 120 and exposed by the opening 132. In this embodiment, the display panel 140 is, for instance, a liquid crystal display (LCD) panel, which should not be construed as a limitation. In other embodiments of the invention, the display panel 140 can also be an organic electroluminescence display (OLED) panel or any other appropriate display panel.

Since the frame 120 includes the parts 122, 124, 126, and 128 that can be separately delivered and individually processed during fabrication, the frame 120 can be easily made. For instance, if the part 122 of the frame 120 is the only part that needs to be spray painted, the part 122 can be independently spray painted before the parts 122, 124, 126, and 128 are engaged and locked to assemble the frame 120, such that the step of covering the parts 124, 126, and 128 can be omitted. Besides, a plurality of the parts 122 can be simultaneously spray painted, so as to improve the work efficiency. Additionally, if a polishing process or an embossing process is required to be performed on the surface of the frame 120, the parts 122, 124, 126, and 128 can be processed before the parts 122, 124, 126, and 128 are engaged and locked to assemble the frame 120. Since the non-processed parts 122, 124, 126, and 128 are small in size, the processing costs can be reduced.

The parts 122, 124, 126, and 128 are locked together by engagement and then connected to the back cover 110. Therefore, when the frame 120 is connected to the back cover 110, it is not necessary to fix the relative positions of the parts 122, 124, 126, and 128 by using a fixture. As such, the assembling process can be simplified, and the manufacturing costs and time can be reduced.

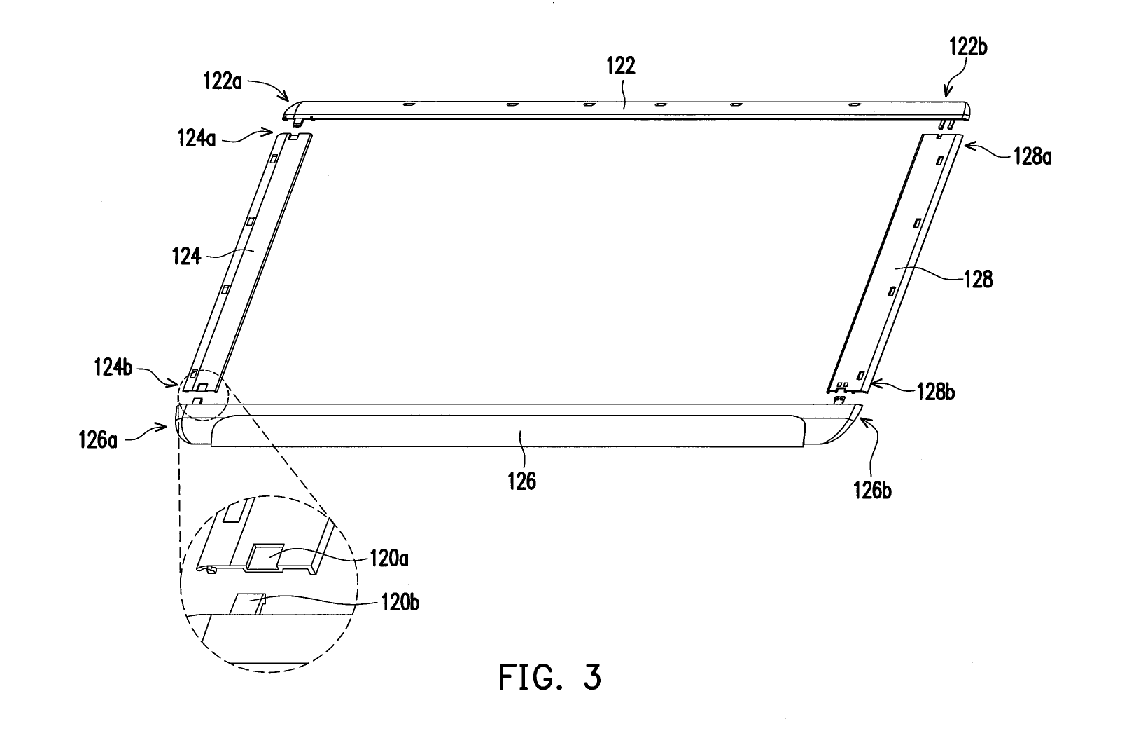

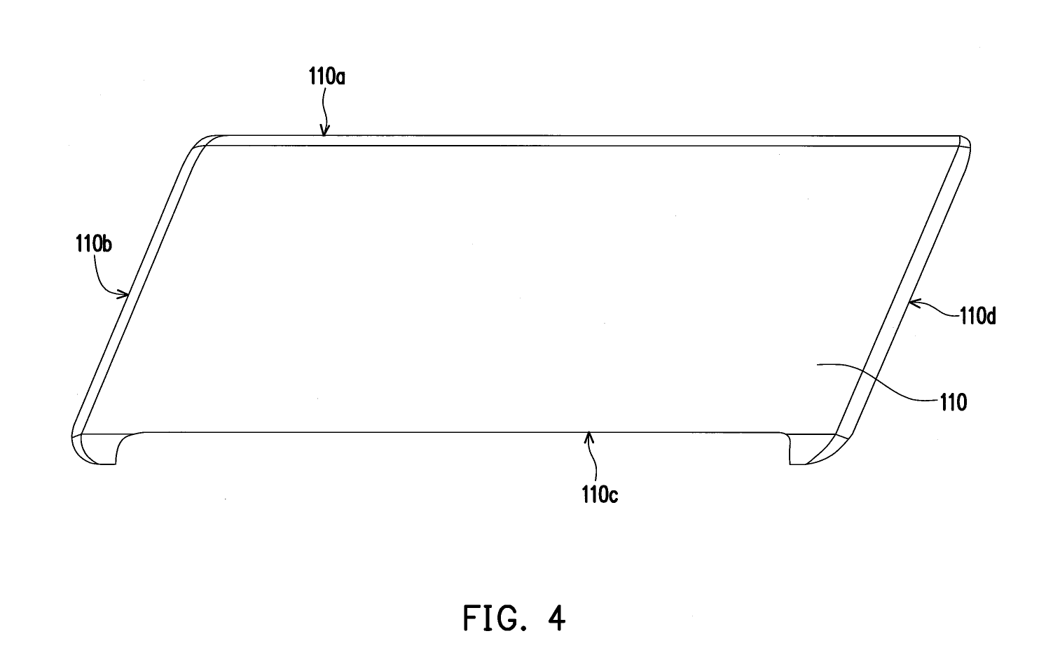

FIG. 3 is an explosive view illustrating the frame depicted in FIG. 2. With reference to FIG. 3, the part 122 of this embodiment has a first end 122a and a second end 122b opposite to the first end 122a, the part 124 of this embodiment has a first end 124a and a second end 124b opposite to the first end 124a, the part 126 of this embodiment has a first end 126a and a second end 126b opposite to the first end 126a, and the part 128 of this embodiment has a first end 128a and a second end 128b opposite to the first end 128a. FIG. 4 is a three-dimensional view illustrating the back cover depicted in FIG. 2. With reference to FIG. 4, the back cover 110 of this embodiment is rectangular and has two long sides 110a and 110c and two short sides 110b and 110d.

As shown in FIG. 2 to FIG. 4, specifically, the part 122 is connected to the long side 110a of the back cover 110. The part 124 is connected to the short side 110b of the back cover 110, and the first end 124a of the part 124 and the first end 122a of the part 122 are locked. The part 126 is connected to the long side 110c of the back cover 110, and the first end 126a of the part 126 and the second end 124b of the part 124 are locked. The part 128 is connected to the short side 110d of the back cover 110. The first end 128a of the part 128 and the second end 122b of the part 122 are locked, and the second end 128b of the part 128 and the second end 126b of the part 126 are locked.

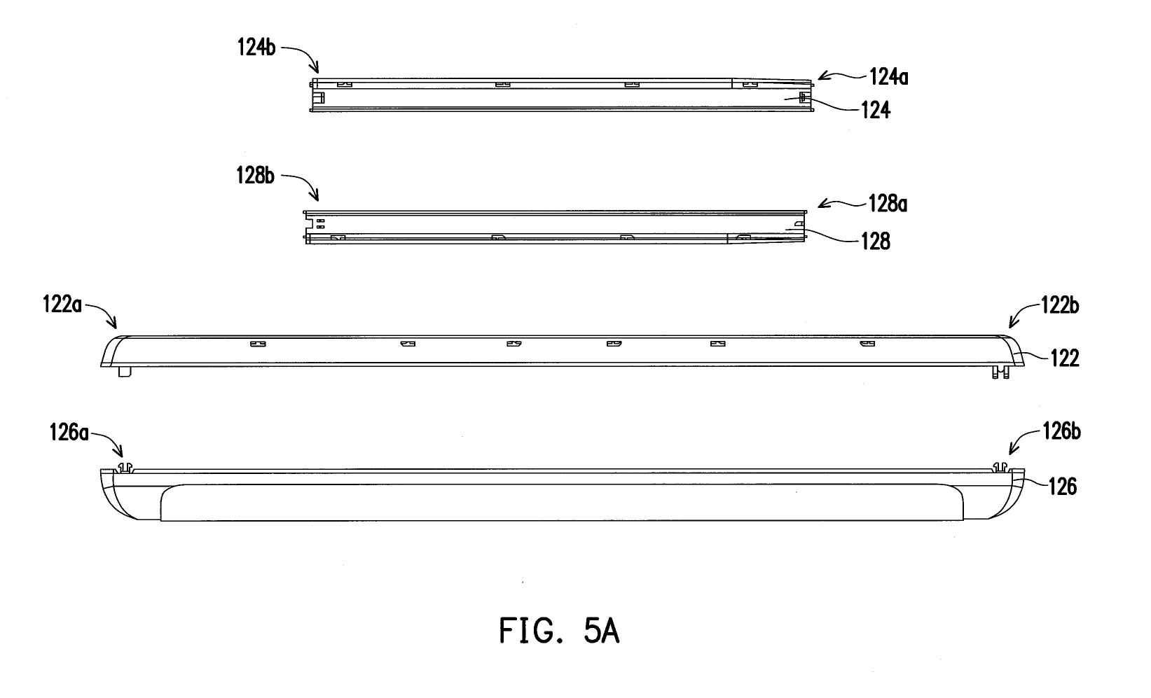

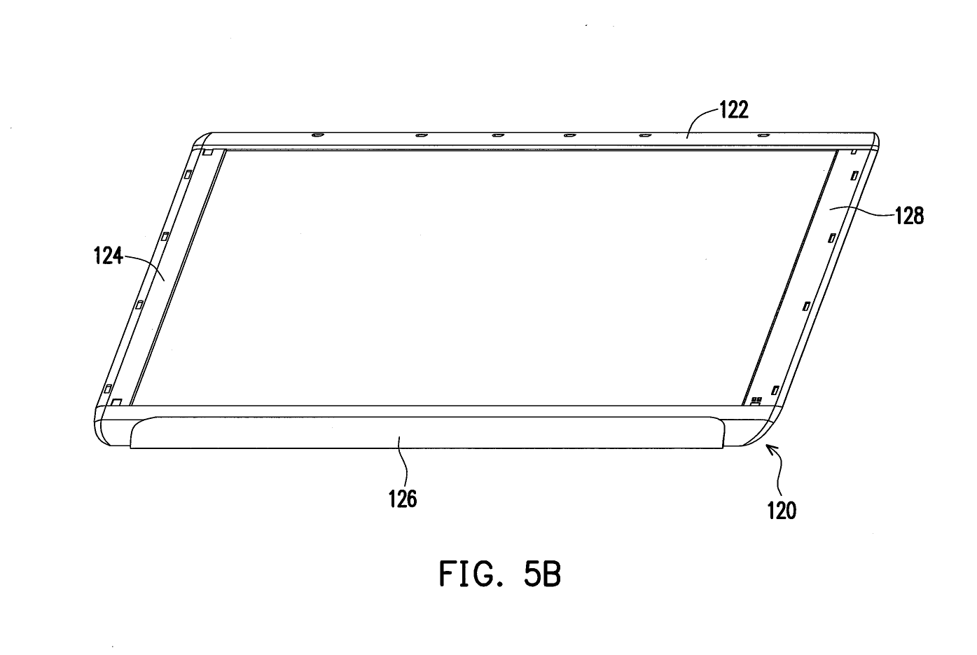

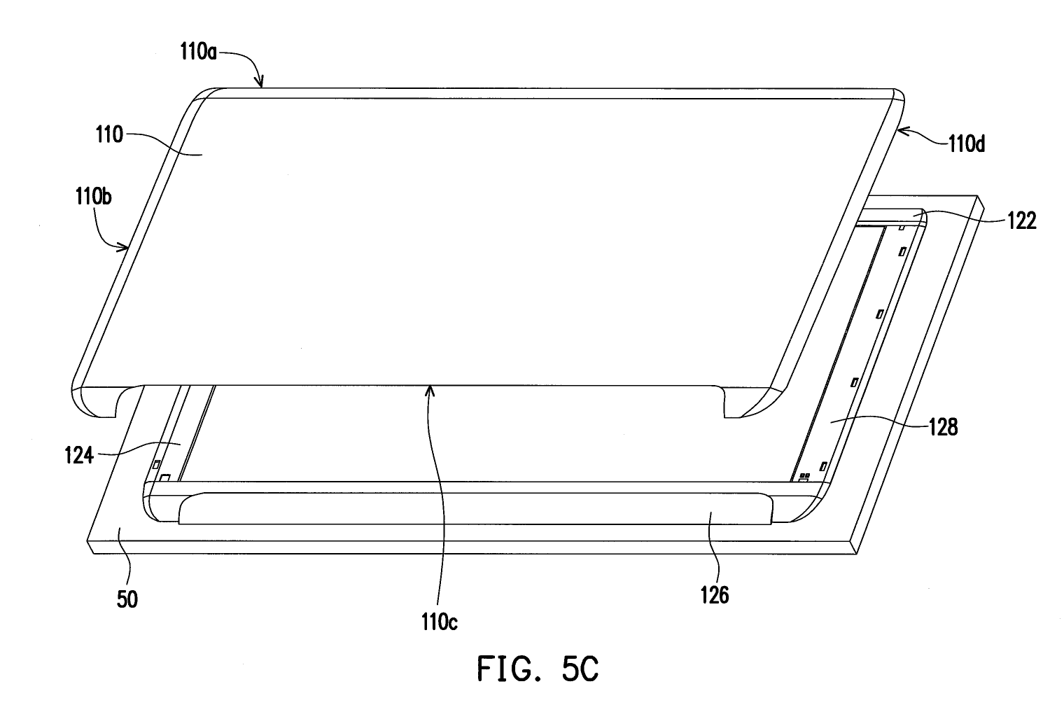

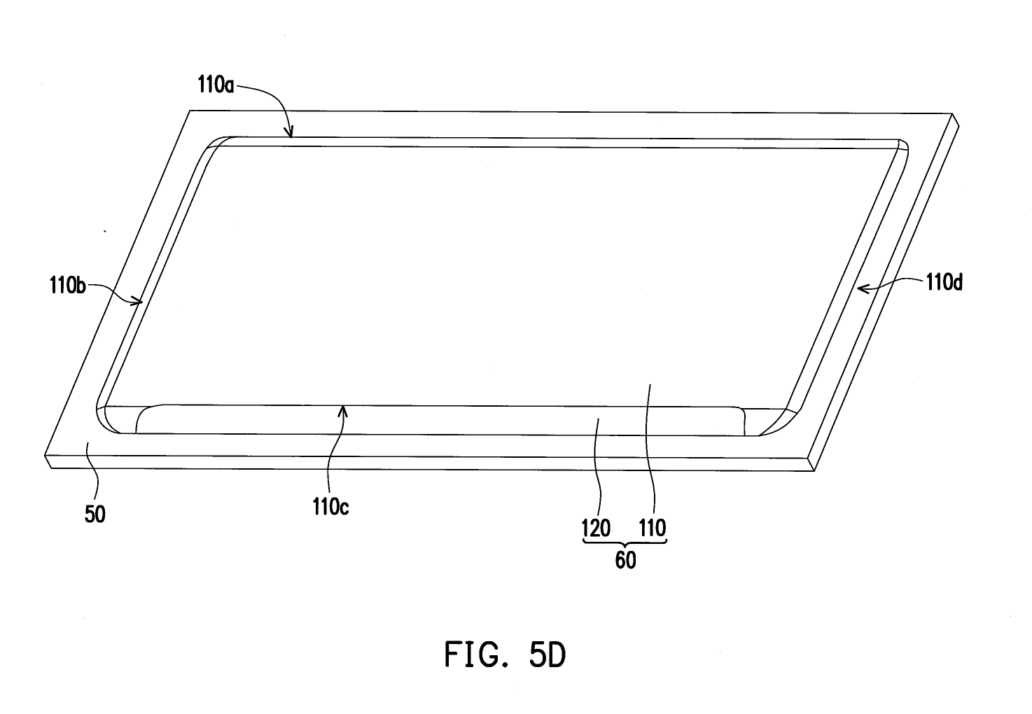

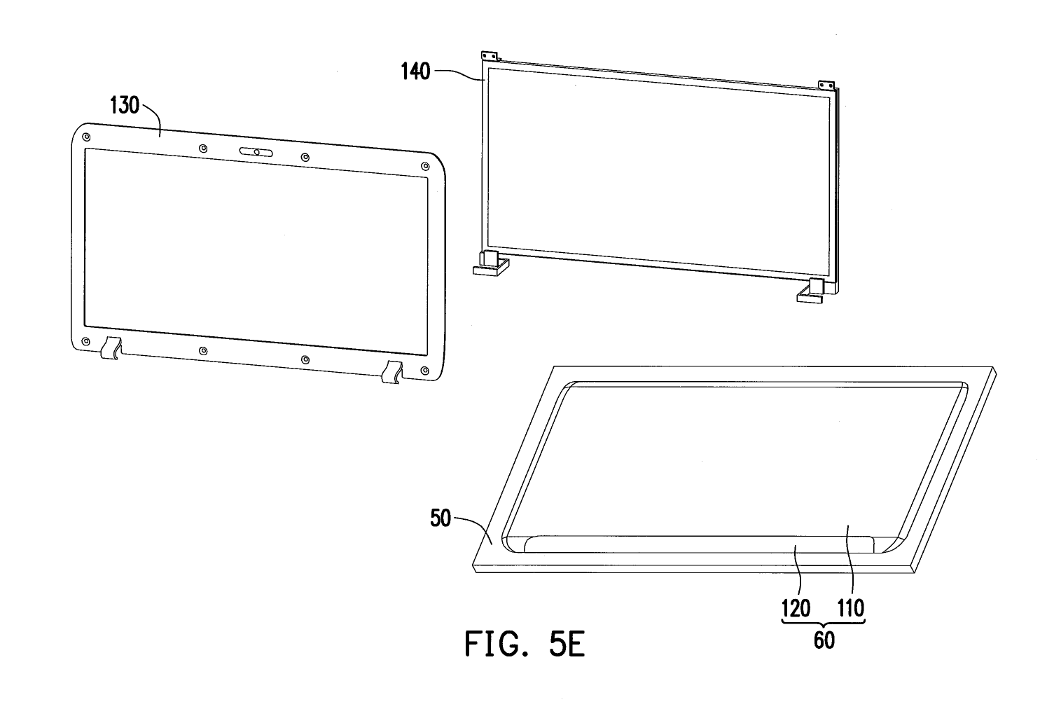

The parts 122, 124, 126, and 128 of this embodiment are made of plastic, while the parts 122, 124, 126, and 128 described in other embodiments can be made of a metallic material, such as aluminum, magnesium, and so on. Besides, the parts 122, 124, 126, and 128 can be made of the same material, which should not be construed as a limitation. The material of one of the parts 122, 124, 126, and 128 can be different from the material of another of the parts 122, 124, 126, and 128. The back cover 110 is made of aluminum or other metallic materials, for instance. The parts 122, 124, 126, and 128 are connected to the back cover 110 by thermal compression, for instance. In addition, as shown in FIG. 3, the part 124 has a slot 120a, and the part 126 has a locking hook 120b. The parts 124 and 126 are engaged and locked by the locking hook 120b that locks the slot 120a. The engagement between the parts 122 and 124, the engagement between the parts 122 and 128, and the engagement between the parts 126 and 128 are similar to that described above, and therefore no further description is provided herein. The assembling method of the computer back cover 60 depicted in FIG. 2 is elaborated with reference to FIG. 5A to FIG. 5E.

FIG. 5A to FIG. 5E illustrate a process for assembling the computer back cover depicted in FIG. 2. With reference to FIG. 5A, the parts 122, 124, 126, and 128 are provided. With reference to FIG. 5B, the frame 120 is assembled by locking the parts 122, 124, 126, and 128 by engagement. With reference to FIG. 5C, the back cover 110 is provided. Here, the frame 120 is placed on a platform 50 for subsequent assembly. With reference to FIG. 5D, the frame 120 is connected to the back cover 110, so as to assemble the computer back cover 60. The frame 120 and the back cover 110 are connected by thermal compression, for instance. During the thermal compression, the frame 120 or the back cover 110 is coated with an adhesive, and the frame 120 and the back cover 110 are heated, compressed, and then combined. With reference to FIG. 5E, the bezel 130 and the display panel 140 are provided. The bezel 130 has the opening 132. The display panel 140 is assembled between the bezel 130 and the frame 120, such that the opening 132 exposes the display panel 140. The electronic device 100 depicted in FIG. 1 is then completely assembled.

Particularly, in the assembling steps depicted in FIG. 5A to FIG. 5B, the first end 124a of the part 124 and the first end 122a of the part 122 are engaged to lock, the first end 126a of the part 126 and the second end 124b of the part 124 are engaged to lock, the first end 128a of the part 128 and the second end 122b of the part 122 are engaged to lock, and the second end 126b of the part 126 and the second end 128b of the part 128 are engaged to lock. Besides, in the assembling steps depicted in FIG. 5C to FIG. 5D, the part 122 is connected to the long side 110a of the back cover 110, the part 124 is connected to the short side 110b of the back cover 110, the part 126 is connected to the long side 110c of the back cover 110, and the part 128 is connected to the short side 110d of the back cover 110.

In light of the foregoing, the frame includes the parts according to the invention. Therefore, during fabrication, each of the parts can be separately delivered and individually processed, so as to facilitate the manufacture of the frame. In addition, the parts are locked together by engagement and then connected to the back cover, so as to assemble the computer back cover. Hence, when the frame is connected to the back cover, it is not necessary to fix the relative positions of the parts by using a fixture, which simplifies the assembling process and reduces the manufacturing costs and time.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device comprising:
a computer back cover comprising:
a back cover; and
a frame comprising a plurality of parts, the parts being locked together by engagement and connected to the back cover;
a bezel assembled to the parts and having an opening; and
a display panel assembled between the bezel and the parts and exposed by the opening.

2. The electronic device as claimed in claim 1, wherein the back cover is rectangular, and the parts comprise:
a first part connected to one long side of the back cover;
a second part connected to one short side of the back cover, a first end of the second part and a first end of the first part being locked;
a third part connected to the other long side of the back cover, a first end of the third part and a second end of the second part being locked; and
a fourth part connected to the other short side of the back cover, a first end of the fourth part and a second end of the first part being locked, a second end of the fourth part and a second end of the third part being locked.

3. The electronic device as claimed in claim 2, wherein the first end is a locking hook and the second end is a slot.

4. The electronic device as claimed in claim 1, wherein the parts are connected to the back cover by thermal compression.

5. The electronic device as claimed in claim 1, wherein a material of the parts is plastic, aluminum, or magnesium.

6. The electronic device as claimed in claim 1, wherein one of the parts and another one of the parts are made of different materials.

7. The electronic device as claimed in claim 1, wherein a material of the back cover is metal.

8. The electronic device as claimed in claim 7, wherein the material of the back cover is aluminum.

9. A computer back cover adapted to an electronic device, the electronic device having a bezel and a display panel, the bezel having an opening, the computer back cover comprising:
a back cover; and
a frame comprising a plurality of parts, the parts being locked together by engagement and connected to the back cover, the bezel being assembled to the parts, the display panel being assembled between the bezel and the parts and exposed by the opening.

10. The computer back cover as claimed in claim 9, wherein the back cover is rectangular, and the parts comprise:
a first part connected to one long side of the back cover;
a second part connected to one short side of the back cover, a first end of the second part and a first end of the first part being locked;
a third part connected to the other long side of the back cover, a first end of the third part and a second end of the second part being locked; and
a fourth part connected to the other short side of the back cover, a first end of the fourth part and a second end of the first part being locked, a second end of the fourth part and a second end of the third part being locked.

11. The computer back cover as claimed in claim 10, wherein the first end is a locking hook and the second end is a slot.

12. The computer back cover as claimed in claim 9, wherein the parts are connected to the back cover by thermal compression.

13. The computer back cover as claimed in claim 9, wherein a material of the parts is plastic, aluminum, or magnesium.

14. The computer back cover as claimed in claim 9, wherein one of the parts and another one of the parts are made of different materials.

15. The computer back cover as claimed in claim 9, wherein a material of the back cover is metal.

16. The computer back cover as claimed in claim 9, wherein the material of the back cover is aluminum.

17. An assembling method of a computer back cover, comprising:
assembling a frame by locking a plurality of parts by engagement;
connecting the frame to a back cover to assemble the computer back cover,
wherein the computer back cover is connected to a bezel and a display panel through assembling the display panel between the bezel and the frame and exposing the display panel by an opening of the bezel.

18. The assembling method as claimed in claim 17, wherein the parts comprise a first part, a second part, a third part, and a fourth part, and a method of assembling the frame by locking the parts comprises:
locking a first end of the second part and a first end of the first part;
locking a first end of the third part and a second end of the second part;
locking a first end of the fourth part and a second end of the first part; and
locking a second end of the third part and a second end of the fourth part.

19. The assembling method as claimed in claim 18, wherein the first end is a locking hook and the second end is a slot.

20. The assembling method as claimed in claim 18, wherein the back cover is rectangular, and a method of connecting the frame to the back cover comprises:
connecting the first part to one long side of the back cover;
connecting the second part to one short side of the back cover;
connecting the third part to the other long side of the back cover; and
connecting the fourth part to the other short side of the back cover.

21. The assembling method as claimed in claim 17, wherein a method of connecting the frame to the back cover comprises thermal compression.

22. The assembling method as claimed in claim 21, wherein a method of thermally compressing the frame onto the back cover comprises:
coating the frame or the back cover with an adhesive; and
heating and compressing the frame and the back cover.
